(19) United States
(12) Patent Application Publication
(10) Pub. No.: US 2014/0155052 A1
(43) Pub. Date: Jun. 5, 2014

(54) MOBILE DEVICE SERVICES CONTROL SYSTEM AND METHOD

(71) Applicant: Kenneth Matthew Glover, Coppell, TX (US)

(72) Inventor: Kenneth Matthew Glover, Coppell, TX (US)

(21) Appl. No.: 14/085,582

(22) Filed: Nov. 20, 2013

Related U.S. Application Data
(60) Provisional application No. 61/728,617, filed on Nov. 20, 2012.

(51) Int. Cl. H04W 4/04

(52) U.S. Cl. CPC H04W 4/046
USPC 455/419

(57) ABSTRACT

A system provides a means to enable and disable predetermined mobile device services to prevent driver distraction while operating a motor vehicle. Once a vehicle is turned on the Mobile Device Service Control algorithm determines a mobile device(s) and vehicle location to determine their proximity to each other. Services are enabled or disabled depending on the result of proximity determination.

### CROSS-REFERENCE TO RELATED APPLICATIONS AND CLAIM OF PRIORITY

The present application claims priority to U.S. Provisional Patent Application Ser. No. 61/728,617, filed Nov. 20, 2012, entitled “MOBILE DEVICE SERVICES CONTROL SYSTEM AND METHOD”. The content of the above-identified patent document is incorporated herein by reference.

### TECHNICAL FIELD

This application relates to mobile device network services control based on device locations and, more specifically, the regulation and control of potential distractions while in areas of desired use restriction.

### BACKGROUND

This section does not describe prior art as defined for purposes of anticipation or obviousness under 35 U.S.C. section 102 or 35 U.S.C. section 103. Thus, nothing stated in the BACKGROUND is to be construed as prior art.

Mobile devices abound in people's daily lives. It used to be that pagers were the most advanced wireless devices people had to keep informed and up to date. With the explosion of wireless technology and the innovation of wireless devices and platforms, people now carry a multitude of items that constantly vie for our attention. The fact that these devices are extremely portable and offer a number of useful options, can lead people to become too easily distracted by the mobile devices. For example, in a social setting, like a restaurant, it is readily apparent and often the case that all of the people at a particular table have their heads down, deeply engrossed in their mobile device. This is a scenario that poses no real danger, but when the temptation is so high to use a device at any point during the day, then serious safety issues may arise.

A typical stereotype of the distracted driver is the person that is eating, applying makeup, reading a newspaper, or messing with the radio in the vehicle and not focused on the act of driving, much less, driving safely. The distracted driver profile has changed as our technology has advanced. The list of typical distractions has grown to include the use of mobile phones and other portable devices. The temptation to use these devices is so great that it poses a serious danger while driving. The danger is so pervasive that federal legislation has been enacted to prohibit the use of devices in and near school zones. Additional legislation mandates the use of hands free systems to further reduce the danger of using a mobile device while driving in certain areas.

The problem now exists where texting and the use of social media, along with voice, are introducing another distraction, especially with younger drivers. The increase of accidents that have caused serious injuries and death have heightened the awareness of the issue and have sparked innovation in attempts to address the situation. Additionally, the danger also exists as fleet and professional drivers have access to mobile technology and are distracted, creating a large liability for their employers when they are involved in an accident.

There are a number of solutions on the market that provide various methods to prevent drivers, especially teens, from using their mobile devices while in a motor vehicle. While these solutions warrant merit, they typically fall short in that most can be circumvented by the user. For example, most solutions require software that runs on the device to control use of voice and data. Most users can easily figure out how to stop the software or remove it completely. Another approach integrates the use of BLUETOOTH (or other short-range wireless) technology to determine if a user is in a vehicle. Again, users can easily turn off the BLUETOOTH (or other short-range wireless) functionality of their handset to circumvent the blocking of voice and/or data while they are in their vehicle. The use of BLUETOOTH technology typically requires users to perform a “pairing” process which requires additional user involvement and interaction.

### SUMMARY

To address the above-discussed deficiencies, a mobile device service management platform is provided. The mobile device service management platform includes a microcontroller configured to send mobile device data to a carrier network. The mobile device data includes an indication that a specified mobile device is ON. The microcontroller is also configured to: in response to a determination the specified mobile device is in a same location as a vehicle having a vehicle status of ON, receive a control signal from the carrier disabling a designated wireless service to the specified mobile device.

A non-transitory computer readable medium embodying a computer program is provided. The computer program includes computer readable program code that, when executed by processing circuitry, causes the processing circuitry to receive vehicle data from a tracking device. The vehicle data includes a vehicle status of a vehicle. The computer readable program code causes the processing circuitry to determine whether a vehicle status is ON. The computer readable program code causes the processing circuitry to determine whether a specified mobile device is ON. Also, the computer readable program code causes the processing circuitry to receive mobile device data from the specified mobile device. The computer readable program code further causes the processing circuitry to determine whether the specified mobile device is in a same location as the vehicle. The computer readable program code causes the processing circuitry to in response to determining the specified mobile device is in the same location as the vehicle, disable a designated wireless service or services to the specified mobile device.

A Mobile Device Services Control system is provided. The system includes a tracking device. The tracking device is configured to: couple to a vehicle, determine whether a vehicle status of the vehicle is ON, and send vehicle data to a server and broadcast an audio signal within the vehicle. In response to a mobile device detecting the audio signal a designated wireless service for the mobile device is disabled.

Other features and embodiments of the present disclosure may be apparent to those of ordinary skill in the art. After reading the specification, the detailed description of the embodiments, and the attached appendix, these persons will recognize that similar results can be achieved in not dissimilar ways. Accordingly, the detailed description is provided as an example for illustration, and it should be understood that the invention is not limited by the detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the teem “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a Mobile Device Services Control system according to embodiments of the present disclosure;

FIG. 2 illustrates a Mobile Device Services Control process according to embodiments of the present disclosure; and

FIG. 3 illustrates a Mobile Device Services Control system 100 according to embodiments of the present disclosure.

### DETAILED DESCRIPTION

When reading this section, one should keep in mind several points. First, included in the following embodiments is what the inventor believes to be the best mode for practicing the invention at the time this patent was filed. Thus, since one of ordinary skill in the art may recognize from the following embodiments that substantially equivalent structures or substantially equivalent acts may be used to achieve the same results in exactly the same way, or to achieve the same results in a not dissimilar way, the following embodiments should not be interpreted as limiting the invention to one embodiment.

Likewise, individual aspects (sometimes called species) of the invention are provided as examples, and, accordingly, one of ordinary skill in the art may recognize from a following example structure (or a following example act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, certain aspects of the present disclosure are identified in the claims. Aspects of the disclosure as claimed, including elements, acts, functions, and relationships (shown or described) should not be interpreted as being essential unless they are explicitly described and identified as being essential.

Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising”) should be interpreted in the inclusive, not the exclusive, sense.

Fifth, the words “means” and “step” are provided to facilitate the reader's understanding of the present disclosure and do not mean “means” or “step” as defined in 35 U.S.C. §112, paragraph 6, unless used as “means for —functioning—” or “step for —functioning—” in the CLAIMS section.

Examples of Mobile Device Services Control Systems are referenced in U.S. Pat. Nos. 7,197,321 and 7,206,569 issued to their applicants on Mar. 27, 2007 and Apr. 17, 2007 respectively, which patents are incorporated herein by reference. Such control systems include a component that restricts service on a mobile device and is compared to values entered in a user profile account to determine if specific access to services is allowed.

Such systems and methods utilize pre-determined data that is entered into a user profile. While this may be effective, it does not allow for the dynamic comparison of the user device location to the location of an actual motor vehicle and the operational state of that motor vehicle. In contrast, embodiments of the present disclosure utilize real-time information from both the mobile device and an associated motor vehicle to determine the operational state of both components to regulate services on a mobile device that could potentially distract a driver operating a motor vehicle.

U.S. Pat. Nos. 7,197,321 and 7,206,569 specify that restrictions and rules are processed on the handset/device. In contrast, embodiments of the present disclosure utilize the processing power of a server to accommodate the execution of service restrictions and send specific device instructions to the handset/device platform. U.S. Pat. Nos. 7,197,321 and 7,206,569 limit usage specifically to preset times designated on a server platform that is tied to a specific user profile/account. In contrast, embodiments of the present disclosure dynamically controls\ service features based on the status and location of a handset/device, specifically when the device is known to be located in a registered vehicle. The patents above generically reference micro controllers and handset/device logic execution as the means for controlling handset/device capabilities. Embodiments of the present disclosure also utilize the Subscriber Identity Module (SIM) Toolkit and other account management platform(s) to be used for handset/device control and interfacing.

U.S. Pat. No. 7,197,321 utilizes motion and speed of a handset/device to determine if a device is in motion and services should be restricted. In contrast, embodiments of the present disclosure utilize a vehicle-based device to determine if a handset/device is to be checked for presence and subsequently controlled.

U.S. Pat. No. 7,206,569 specifies the use of BLUETOOTH or other short-range wireless technology as a means for detecting handset/device presence. In contrast, embodiments of the present disclosure utilize audio signals to determine if a handset/device is within proximity of a vehicle-enabled tracking device.

Regarding presence detection, patent application Ser. No. 12/762,556, publication number U.S. 2011/0029370 A1, references the use of ultrasonic sound as a means for detecting the presence of a mobile handset/device within a retail environment. Patent Application publication number US 2011/0029370 A1 also encodes information into the signal to provide details about the location and other aspects of a retail interaction. Certain embodiments of the disclosure only check for presence of sound, preferably in the ultrasonic range, that a consumer electronic handset/device can process. Certain embodiments of the present disclosure are specifically designed for use in a motor vehicle environment. Patent application Ser. No. 12/066,770, publication number US 2009/0310792 A1, specifies the use of handset/device audio input to determine presence and current status for interaction with other users of the system. Embodiments of the present disclosure are focused on determining the presence of an audio signal to determine proximity within a motor vehicle while that vehicle is in operation.

Patent application Ser. No. 12/652,791, publication number U.S. 2010/0148920 A1, describes an automated presence detector for motor vehicles. In contrast, embodiments of the present disclosure offer different methods, not specified in the prior art, that offer a unique and more compelling solution alternatives. For example, in the embodiments described for matching a handset/device to a vehicle, only the use of wireless radio technologies and methods are mentioned. In contrast, embodiments of the present disclosure utilize sonic methods to determine presence. Certain embodiments also describe an application running on the handset/device operating system that will enable/disable functionality. However, embodiments of the present disclosure specifically eliminate and avoid the need to have an application running on a handset/device operating system. The method of the present disclosure utilizes a common account management and/or SIM card environment to facilitate the sensing and subsequent limitation of features and services. A combination of service provider tools that are commonly available and the standardized handset/device platform is used to limit features and services in embodiments of the present disclosure.

Embodiments of the present disclosure provide many advantages as a solution that easily and effectively prevents, and or limits the use of voice or data services on a mobile device. The mobile device can be any portable electronic device that facilitates voice and/or data communication. Embodiments of the present disclosure provide seamless functionality for supported cellular communication devices and their associated services regardless of the hardware manufacturer or mobile device operating system. The system will provide easy management of features and services by designated account owners.

The solution can also be applied to other, less critical applications, where the use of mobile technology is desired like in an aircraft or movie theater. The solution is easily adapted with no modification required to the fundamental features.

The Mobile Device Services Control System and Method include two separate functional components. The first functional component is a system that includes an application that runs on the device Subscriber Identity Module (SIM) card or related carrier-owned account management interface/platform and a vehicle. The SIM and account management interfaces that are available provide regulated, programmatic service controls from the platform. For example, mobile network operators that utilize the Global System for Mobile Communications (GSM) technology, support the SIM Toolkit Applications (STA) standard whereby small software programs can be run on the SIM card thus eliminating the need for handset/device-specific operating system support. The SIM card is a micro controller capable of executing algorithms required to manage mobile device services and operations. The STA communicates with a server application that controls the use of certain services depending on the location of the handset/device. The second functional component includes a method that is used to identify location of a vehicle paired with a device used for tracking vehicle location and a user handset/device. The method considers the proximity of mobile device and determines the services that are allowed based on the location of both. If the user handset/device is in a designated vehicle and the vehicle is running, limited voice calls and data, all texting is suspended until the vehicle is turned off. When the vehicle is turned off, normal services are restored to the account tied to the mobile device.

Embodiments of the present disclosure illustrate a Mobile Device Services Control System and Method. In certain embodiments, a system provides a means, using a vehicle-installed tracking device and a mobile handset/device component that blocks the use of pre-determined services that could cause distraction to the operator of a motor vehicle. In certain embodiments, a method that uses an embedded algorithm, instructions or process on the user SIM Card or account management interface/platform associated with a mobile handset/device in conjunction with server algorithms and instructions to limit the services available for use while a vehicle is in operation.

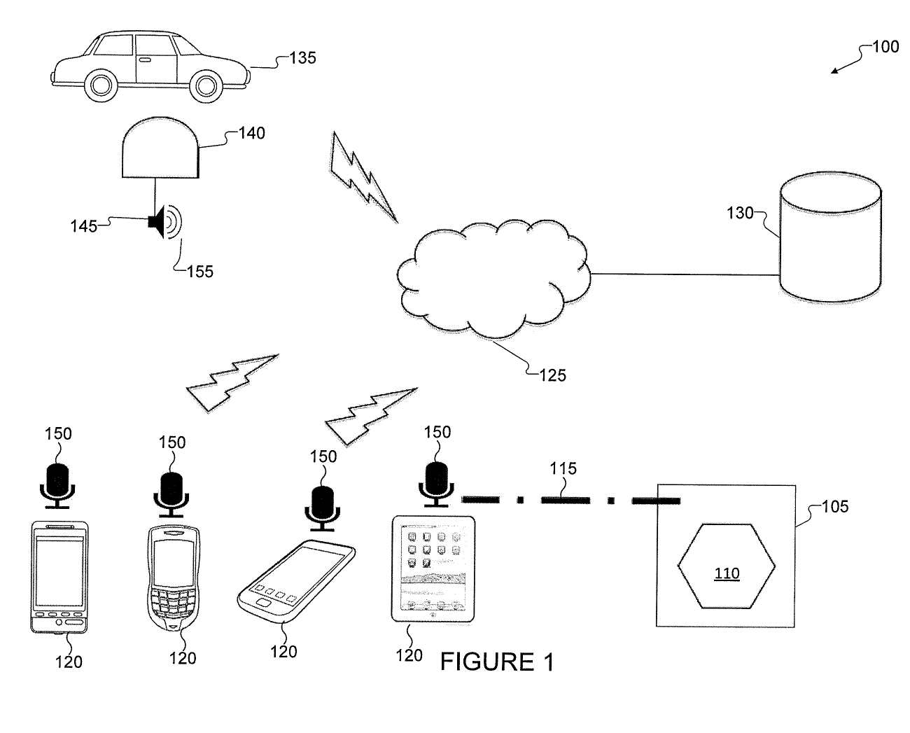

Reference is now made to the figures, and in particular with reference to FIG. 1, which illustrates a Mobile Device Services Control system 100 according to embodiments of the present disclosure. The embodiment of the present disclosure shown in FIG. 1 is for illustration only. Other embodiments could be used without departing from the scope of the present disclosure.

In certain embodiments, the Mobile Device Modular Services Control system 100 includes a mobile device service management platform (for example, SIM card, etc.) 105 composed of a micro controller 110 capable of executing a Mobile Device Services Control algorithm, and a bus 115 coupled to the mobile handset/device services management platform 105 and micro controller 110. The mobile device service management platform 105 is embedded in or connected to a mobile device 120 via a bus 115 and will run the Mobile Device Services Control algorithm that is available over a wireless network interface 125. Mobile Device Services Control algorithm instructions are sent to the micro controller 110 from a server platform 130 via a wireless network interface 125. Location and vehicle status information is sent over a wireless network interface 125 from a motor vehicle 135 to a wireless tracking device 140 is coupled.

For example, the logic could be a service disable or enable sequence, thus disabling or enabling pre-determined mobile device services (voice, text, data) on mobile device(s) 120 by analyzing wireless tracking device 140 and mobile device 120 proximity to each other and sending appropriate instructions from server platform 130 over wireless network 125 to micro controller 110. In one example, the micro controller 110, is a SIM card. The SIM card is capable of executing instructions and interfacing with a handset/device 120 over a communication bus 115. The commands sent to the handset/device 120 can be in the form of standardized modem communication commands such as Attention or AT commands. The SIM card executes and processes instructions that perform specific functions like monitoring for an inbound text message and/or dialing a specific phone number. These features and implementation or other similar processes apparent to those skilled in the art of SIM application development. In a preferred example, the wireless network 125 and devices 120 could utilize GSM, GPRS, CDMA, 1XRTT, EDGE, UMTS, WiFi, LTE, WiMax or other technology known to those skilled in the art of wireless devices and wireless technologies. Of course, it should be understood that the devices provided herein are examples only, and any type of mobile wireless tracking device that couples to a vehicle or portable device used by a human are germane to the present disclosure.

In certain embodiments, the mobile devices 120 could be any consumer device that is coupled to a wireless network 125. The devices could be mobile phones, tablets, portable gaming devices, or any other portable wireless device apparent to those skilled in the art of wireless and mobile devices.

In certain embodiments, the wireless tracking device 140 could be a tracking device that connects to a vehicle via (On-Board Diagnostics II) OBDII communication bus, Controller Area Network (CAN), Society of Automotive Engineers (SAE) J1939 vehicle bus, standard power, standard control lines (starter, ignition, etc.) and any other vehicle interfaces apparent to those skilled in the art of vehicle systems and communication buses. In a separate embodiment, the wireless tracking device 140 could be a simple data collection device that captures driving behavior like harsh braking and rapid acceleration along with OBDII, CAN, J1939 and other data that is analyzed when the device 140 is removed. Accordingly, in certain embodiments, the wireless tracking device includes processing circuitry configured to perform one or more functions and described herein and a memory configured to store data.

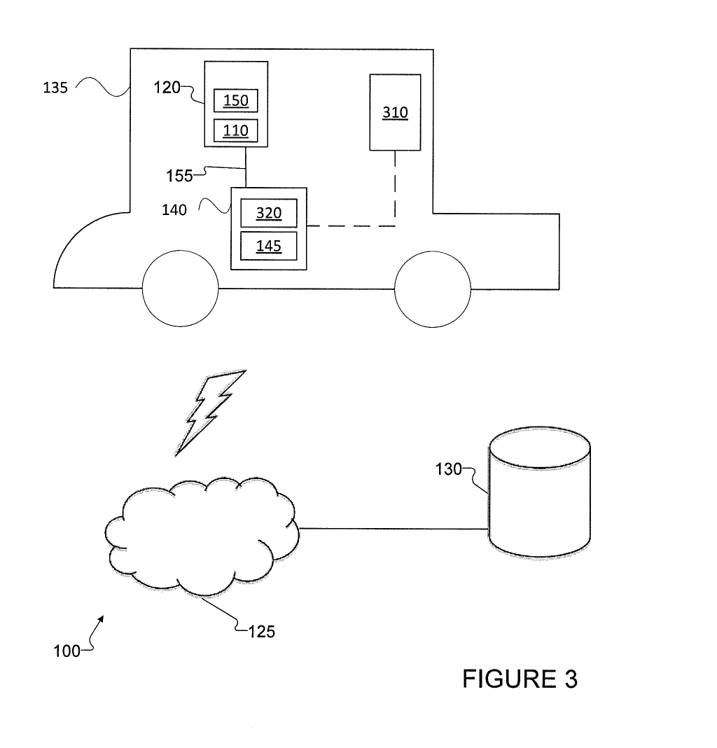

In certain embodiments, the ability to determine proximity between the wireless tracking device 140 and the mobile device 120 utilizes the handset/device microphone 150 on mobile handset/device 120 to listen for a specific tone 155 frequency or pattern emitted from a speaker 145 integrated with the wireless tacking device 140. In certain embodiments, the speaker 145 is tightly integrated within the wireless tracking device 140. In certain embodiments, the speaker 145 is a separate device or attachment that can be used to emit variable tone frequencies (as shown in FIG. 3). The method of determining location proximity by the use of sound may be apparent to those skilled in the art of sonic proximity detection.

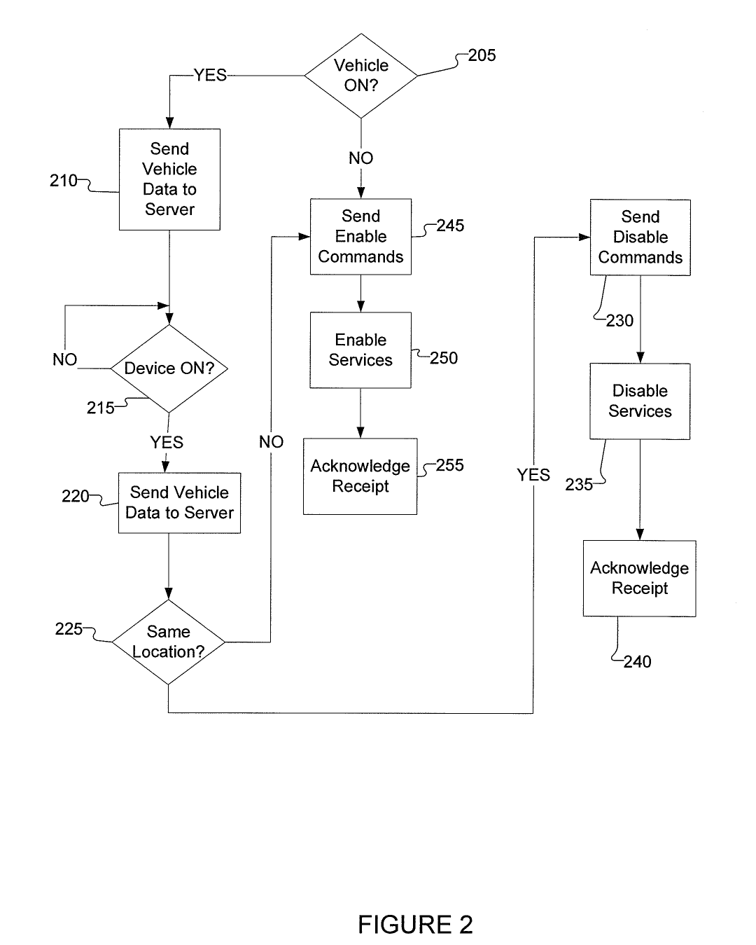

FIG. 2 illustrates a Mobile Device Services Control process 200 according to embodiments of the present disclosure. While the flow charts depict a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps.

In general, the Mobile Device Services Control algorithm 200 processes data collected by the server platform 130 using data sent from vehicle tracking device 140 and mobile device(s) 120 from FIG. 1. Prior to the execution of the algorithms, basic information is collected and stored in a database. The parameters required to make decisions in the algorithm include, but are not limited to, vehicle, user, and user device. The account administrator (e.g., parent or manager) will provide an identifier for vehicles that are being monitored for mobile device use. The user (e.g., teen or driver) information is also provided along with the device/devices that will be monitored. An association is made between each vehicle, user and device to set the monitoring configuration. In certain embodiments, the Mobile Device Services Control algorithm 200 parameters are set depending on the result of the Vehicle ON? determination in block 205 and the Device ON? determination in block 215. When a vehicle is in the ON state, the Send Vehicle Data to Server 210 processes 210 is performed. A Device ON? determination in block 215 is then performed to determine if a mobile device is active within the system. If the Device ON? determination in block 215 result is true, a Send Device Data to Server processes 220 is performed to provide mobile device(s) status and location information to the system. If both determinations, Vehicle ON? in block 205 and Device ON? in block 215, are true, a Same Location? determination in block 225 is performed. When the vehicle 135 is turned ON, data is sent to a server 130 indicating vehicle status and the server checks to see if a device is active on the carrier network via common tools provided by the carrier.

Through the Same Location? determination in block 225, a decision is made that will affect services that are enabled or disabled on the mobile device. In certain embodiments, the Same Location? determination in block 225 is a result of the vehicle tracking device 140 being powered on and the vehicle 135 is in use and the speaker 145 emitting a variable tone 155 whereby the handset/device microphone 150 passes the tone 155 to server platform 130 via a wireless network interface 125 for analysis. In certain embodiments, the method can be used to determine if a mobile device 120 is within the vehicle 135 and is powered ON. If the result of the Same Location? determination block 225 is true, a Send Disable Commands in block 230 is performed to send the command(s) over a network 125 that will initiate a Disable Services process in block 235. The Disable Services process in block 235 will stop the use of designated services. In certain embodiments, the disable function is accomplished by the switching of subscriber account profiles. One subscriber account profile provides their standard service features and a second subscriber profile will provide all of the disabled feature components. For example, the second subscriber profile will disable data, SMS, and will restrict inbound and outbound numbers available. In certain embodiments, the disable function 235 is accomplished by executing logic on the SIM card or other internal subscriber management processor. An Acknowledge receipt process in block 240 is then executed from a mobile device 120 to confirm the Disable Services process in block 235 has been received by the mobile device 120.

If the result of the Same Location? process in block 225 is false, a Send Enable Commands 245 act is performed to send the command(s) over a network that will initiate a Enable Services act 250 which will resume the use of designated services. An Acknowledge Receipt process in block 255 is then executed by a mobile device 120 to confirm the Enable Services process in block 250 has been received by the mobile device 120.

FIG. 3 illustrates a Mobile Device Services Control system 100 according to embodiments of the present disclosure. The embodiment of the Mobile Device Services Control system 100 shown in FIG. 3 is for illustration only. Other embodiments could be used without departing from the present disclosure.

The vehicle 135 includes a vehicle interface 310, such as (On-Board Diagnostics II) OBDII communication bus, Controller Area Network (CAN), Society of Automotive Engineers (SAE) J1939 vehicle bus, standard power, standard control lines (starter, ignition, etc.) and any other suitable vehicle interface for coupling to the tracking device 140. The tracking device 140 receives information from the vehicle interface regarding whether the vehicle status is ON or OFF.

The tracking device 140 is located, such as mounted, installed or removably placed, in the vehicle 135. In certain embodiments, the tracking device 140 includes a speaker 145 that emits a signal 155 that is not audible to human ears, such as a high frequency signal or a sonic signal. In certain embodiments, the tracking device 140 includes subscriber equipment (for example, SIRIUS XM satellite radio equipment) that emits a tone 155. That is, a subscriber equipment of a satellite radio network (for example, SIRIUS XM) can emit the tone 155 that is then received by the receiver 150 of the mobile device 120. The tone 155 can be emitted in response to a mode of a car ignition, including an accessories mode (ACC), an ON mode, or a start mode. The accessories mode activates electrical accessories (for example, radio, GPS, lights, etc.). The ON mode activates components (for example, fuel pump, fuel injectors). The start mode activates the starter of the vehicle. The tracking device 140 includes a communication interface 320 that sends vehicle information to the server 130 via a wireless communication channel.

The mobile device 120 is in the vehicle 135. The mobile device 120 includes a receiver 150 configured to receive the signal 155 emitted by the speaker 145. In certain embodiments, the receiver 150 is a microphone. The mobile device 120 includes the mobile device service management platform 105, which includes the micro controller 110. The mobile device sends mobile device data to the associated carrier's network via a wireless communication channel. In response, one or more servers in the carrier's network identify the profile corresponding to the mobile device 120. The servers identify the actions required by the profile. For example, if the profile indicates that the user (e.g., owner) of the mobile device 120 has subscribed to a service for ceasing text message, the server ceases all text messages to and from the mobile device 120. In certain embodiments, the server allows communications according to specified exceptions as indicated by the subscription, such as emergency calls are emergency broadcast text messages.

Although various features have been shown in the figures and described above, various changes may be made to the figures. For example, the size, shape, arrangement, and layout of components shown in FIGS. 1 and 3 are for illustration only. Each component could have any suitable size, shape, and dimensions, and multiple components could have any suitable arrangement and layout. Also, various components in FIGS. 1 and 3 could be combined, further subdivided, or omitted and additional components could be added according to particular needs. Further, each component in a device or system could be implemented using any suitable structure(s) for performing the described function(s). In addition, while FIG. 2 illustrates various series of steps, various steps in FIG. 2 could overlap, occur in parallel, occur multiple times, or occur in a different order.

It should be apparent to those skilled in the art of wireless networks and devices, specifically mobile devices and networks, that the control of services can be performed in a number of different implementations. In addition, it should also be apparent to those skilled in the art of wireless networks and devices, that there are many alternatives to the management of services in addition to SIM Toolkit methods. Additional details and embodiments are further illustrated in Appendix A, incorporated herein.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A mobile device service management platform comprising:
a microcontroller configured to:
send mobile device data to a carrier network, the mobile device data includes an indication a specified mobile device is ON;
in response to a determination the specified mobile device is in a same location as a vehicle having a vehicle status of ON, receive a control signal from the carrier disabling a designated wireless service to the specified mobile device.

2. The mobile device service management platform of claim 1, wherein the microcontroller is further configured to: in response to at least one of:
a determination the vehicle status is OFF, and
a determination the specified mobile device is not in the same location as the vehicle, receive a control signal from the carrier enabling the designated wireless service to the specified mobile device.

3. The mobile device service management platform of claim 1, wherein the microcontroller is further configured to:
receive a signal from a tracking device of the vehicle through a microphone of the specified mobile device; and
as a result of receiving the signal from the tracking device, receiving the control signal from the carrier disabling the designated wireless service to the specified mobile device.

4. The mobile device service management platform of claim 3, wherein the tracking device is coupled to a vehicle interface comprising at least one of:
an On-Board Diagnostics II (OBDII) communication bus,
a Society of Automotive Engineers (SAE) J1939 vehicle bus, and
a standard control line.

5. The mobile device service management platform of claim 3, wherein the tracking device is configured to: in response to determining the vehicle status is ON, sending vehicle data to a server.

6. The mobile device service management platform of claim 3, wherein the determination the specified mobile device is in the same location as the vehicle having a vehicle status of ON is based on: the received signal from the tracking device of the vehicle through the microphone of the specified mobile device,
wherein the received signal from the tracking device of the vehicle through the microphone of the specified mobile device is emitted from a speaker in the vehicle.

7. The mobile device service management platform of claim 1, wherein the microcontroller is further configured to:
determine the specified mobile device is ON; and
in response to the determination the specified mobile device is ON, send the mobile device data to the carrier network.

8. A non-transitory computer readable medium embodying a computer program, the computer program comprising computer readable program code that, when executed by processing circuitry, causes the processing circuitry to:
receive vehicle data from a tracking device, the vehicle data including a vehicle status of a vehicle;
determine whether a vehicle status is ON;
determine whether a specified mobile device is ON;
receive mobile device data from the specified mobile device;
determine whether the specified mobile device is in a same location as the vehicle; and
in response to determining the specified mobile device is in the same location as the vehicle, disable a designated wireless service to the specified mobile device.

9. The non-transitory computer readable medium of claim 8, wherein the computer program further comprise computer readable program code that, when executed by the processing circuitry, causes the processing circuitry to: in response to at least one of:
a determination the vehicle status is OFF, and
a determination the specified mobile device is not in the same location as the vehicle, enable the designated wireless service to the specified mobile device.

10. The non-transitory computer readable medium of claim 8, wherein the tracking device is coupled to the vehicle via a vehicle interface.

11. The non-transitory computer readable medium of claim 10, wherein the vehicle interface comprises at least one of:
an On-Board Diagnostics II (OBDII) communication bus,
a Society of Automotive Engineers (SAE) J1939 vehicle bus, and
a standard control line.

12. The non-transitory computer readable medium of claim 8, wherein the computer program further comprises computer readable program code that, when executed by the processing circuitry, causes the processing circuitry to:
in response to a determination by the tracking device that the vehicle status is ON, receive the vehicle data.

13. The non-transitory computer readable medium of claim 8, wherein the computer program further comprises computer readable program code that, when executed by the processing circuitry, causes the processing circuitry to:
determine whether the specified mobile device is ON by: determining whether the specified mobile device is active on a carrier network.

14. The non-transitory computer readable medium of claim 8, wherein the computer program further comprises computer readable program code that, when executed by the processing circuitry, causes the processing circuitry to:
determine whether the mobile device is in the same location as the vehicle based on a signal received from a speaker of vehicle through a microphone receiver of the mobile device.

15. A Mobile Device Services Control system comprising:
a tracking device configured to:
couple to a vehicle;
determine whether a vehicle status of the vehicle is ON;
send vehicle data to a server, the vehicle data including the vehicle status; and
broadcast an audio signal within the vehicle, wherein in response to a mobile device detecting the audio signal a designated wireless service for the mobile device is disabled.

16. The system of claim 15, wherein in response to the mobile device detecting the signal, the mobile device transmits a disable signal to a network server and wherein the network server is configured to in response to at least one of:
a determination the vehicle status is OFF, and
a determination the specified mobile device is not in the same location as the vehicle, enable the designated wireless service to the specified mobile device.

17. The system of claim 15, wherein the tracking device is coupled to the vehicle via a vehicle interface,

18. The system of claim 17, wherein the vehicle interface comprises at least one of: an On-Board Diagnostics II (OBDII) communication bus, a Society of Automotive Engineers (SAE) J1939 vehicle bus, and a standard control line.

19. The system of claim 15, wherein in response to the mobile device detecting the signal, the mobile device transmits a disable signal to a network server and wherein the network server is configured to at least one of:
a determination that the mobile device is ON, and
a determination that the specified mobile device is in the same location as the vehicle.

19. The system of claim 19, wherein the determination whether the specified mobile device is ON is based on a determination whether the specified mobile device is active on a carrier network.

20. The system of claim 15, wherein one of the server, the tracking device, and the mobile device is further configured to:
determine whether the mobile device is in the same location as the vehicle based on: a signal received from a speaker of vehicle through a microphone receiver of the mobile device.

21. The system of claim 15, wherein the tracking device includes a satellite radio subscriber equipment.
